(19) United States
(12) Patent Application Publication
(10) Pub. No.: US 2025/0356357 A1
(43) Pub. Date: Nov. 20, 2025

(54) SYSTEM AND METHOD FOR EVALUATING A FINANCIAL CRIME ALERT

(71) Applicant: ACTIMIZE LTD., Ra'anana (IL)

(72) Inventors: Yashodeep KHAIRNAR, Pune (IN); Pradeep KARKI, Pune (IN); Manohar PATIL, Pune (IN); Kiran Kumar BATHULA, Mandamarri (IN)

(21) Appl. No.: 18/665,327

(22) Filed: May 15, 2024

(51) Int. Cl. G06Q 20/40

(52) U.S. Cl. CPC G06Q 20/4016

(57) ABSTRACT

Apparatus, systems, and methods for evaluating a financial crime alert received from a machine learning model (“MLM”) by one or more alert investigation agents. A generative-artificial-intelligence-based (“GenAI-based”) application is queried, using one or more computing devices, via real-time interaction with the alert investigation agent(s), for one or more insights concerning the received financial crime alert. The insight(s) concerning the received financial crime alert are generated by accessing, using the queried GenAI-based application, one or more databases for: (i) information associated with the MLM's development and creation of the financial crime alert by the MLM; (ii) information regarding disposition of one or more historical financial crime alerts comparable to the received financial crime alert; or (iii) both (i) and (ii). The generated insight(s) concerning the received financial crime alert are then visualized, audibilized, or both, via one or more output devices each accessible by the alert investigation agent(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to evaluating financial crime alerts, and, more particularly, to evaluating a financial crime alert received from a machine learning model (“MLM”) by one or more alert investigation agents.

### BACKGROUND

In the course of financial crime detection, alert investigation agents need to review financial crime alerts (e.g., generated for frauds and suspicious money laundering activity) to determine whether the alerts are false positive or true positive. To help with this type of investigation, financial institutions may use machine learning models (“MLMs”) to get a risk score and a corresponding explanation that justifies the risk score by providing contribution scores for different features. However, these explanations often provide very limited insights on how to interpret the risk score and the corresponding explanation, thereby limiting the value realization of MLMs in detecting financial crimes. Also, the investigation may be slowed down because the alert investigation agent(s) do not get the full picture as to why a particular score was given and thus the actual risk. Specifically, the alert investigation agent(s) do not have visibility into the model development process and analysis, or of any statistical analysis of historical alerts within the given financial institution or across the industry, or into historical alerts that are similar to the alert being investigated in order to draw insights.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a diagrammatic illustration of a system for evaluating a financial crime alert received from a machine learning model (“MLM”) by one or more alert investigation agents, according to one or more embodiments of the present disclosure.

FIG. 2A illustrates various tools for retrieving information associated with the MLM's development and creation of the financial crime alert by the MLM, and information regarding disposition of one or more historical financial crime alerts comparable to the received financial crime alert, according to one or more embodiments of the present disclosure.

FIG. 2B illustrates an alternative tool for retrieving information regarding disposition of one or more historical financial crime alerts comparable to the received financial crime alert, according to one or more embodiments of the present disclosure.

FIG. 3A diagrammatically illustrates a hardware architecture (or network architecture), according to one or more embodiments of the present disclosure.

FIG. 3B diagrammatically illustrates an alternative hardware architecture (or network architecture), according to one or more embodiments of the present disclosure.

FIG. 4A diagrammatically illustrates a software architecture, according to one or more embodiments of the present disclosure.

FIG. 4B diagrammatically illustrates an alternative software architecture, according to one or more embodiments of the present disclosure.

FIG. 5 diagrammatically illustrates an example generative-artificial-intelligence (“Gen-AI”) agent service, according to one or more embodiments of the present disclosure.

FIG. 6 illustrates an example of a pre-processing prompt template, which may be employed by one or more embodiments of the present disclosure.

FIG. 7A illustrates an example of a portion of an orchestration prompt template, which may be employed by one or more embodiments of the present disclosure.

FIG. 7B illustrates an example of another portion of the orchestration prompt template shown in FIG. 7A, which may be employed by one or more embodiments of the present disclosure.

FIG. 7C illustrates an example of yet another portion of the orchestration prompt template shown in FIGS. 7A-7B, which may be employed by one or more embodiments of the present disclosure.

FIG. 7D illustrates an example of still yet another portion of the orchestration prompt template shown in FIGS. 7A-7C, which may be employed by one or more embodiments of the present disclosure.

FIG. 8A illustrates an example of a portion of a response generation prompt template, which may be employed by one or more embodiments of the present disclosure.

FIG. 8B illustrates an example of another portion of the response generation prompt template shown in FIG. 8A, which may be employed by one or more embodiments of the present disclosure.

FIG. 9A illustrates an example of a portion of a post-processing prompt template, which may be employed by one or more embodiments of the present disclosure.

FIG. 9B illustrates an example of another portion of the post-processing prompt template shown in FIG. 9A, which may be employed by one or more embodiments of the present disclosure.

FIG. 10 is a flow diagram of an alert investigation, according to one or more embodiments of the present disclosure.

FIG. 11 is a flow diagram of the interactions related to the Gen-AI agent service, according to one or more embodiments of the present disclosure.

FIG. 12A illustrated an example of an alert data (in JSON format), according to one or more embodiments of the present disclosure.

FIG. 12B illustrates an example of the prediction score the alert investigation agent is interested in understanding), according to one or more embodiments of the present disclosure.

FIG. 12C illustrates an example of a feature importance table from model development documents), according to one or more embodiments of the present disclosure.

FIG. 12D illustrates an example of an alert insight), according to one or more embodiments of the present disclosure.

FIG. 13 is a flow diagram of a method for evaluating the financial crime alert received from the MLM by the one or more alert investigation agents, according to one or more embodiments of the present disclosure.

FIG. 14 is a diagrammatic illustration of a computing nod for implementing one or more embodiments of the present disclosure.

### DETAILED DESCRIPTION

The present disclosure introduces a platform that provides alert investigation agent(s) with real time in-context insights and analysis for evaluating a financial crime alert received from a machine learning model (“MLM”). Such insights and analysis may include details of analysis from model development activity, statistical analysis of historical data, and/or domain insights. An example may include insights into historical alerts—similar to current types of alerts but with increased relevant—and their investigation. Specifically, a generative-artificial-intelligence-based (“GenAI-based”) application may interact with the alert investigation agent(s) in a chat mode and, based on said interaction, query historical data to fetch analysis and generate/present insights.

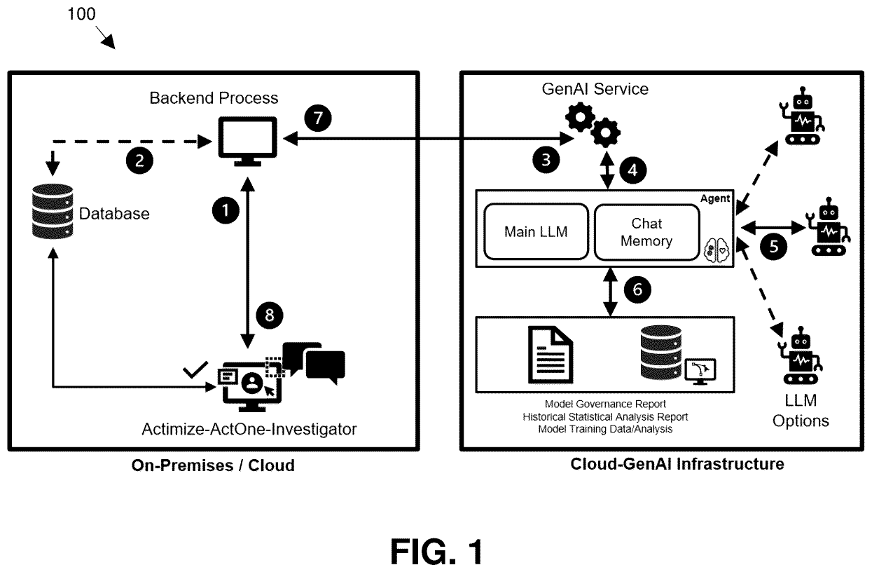

Referring to FIG. 1, in one or more embodiments, a system 100 for evaluating the financial crime alert received from the MLM by the one or more alert investigation agents is illustrated.

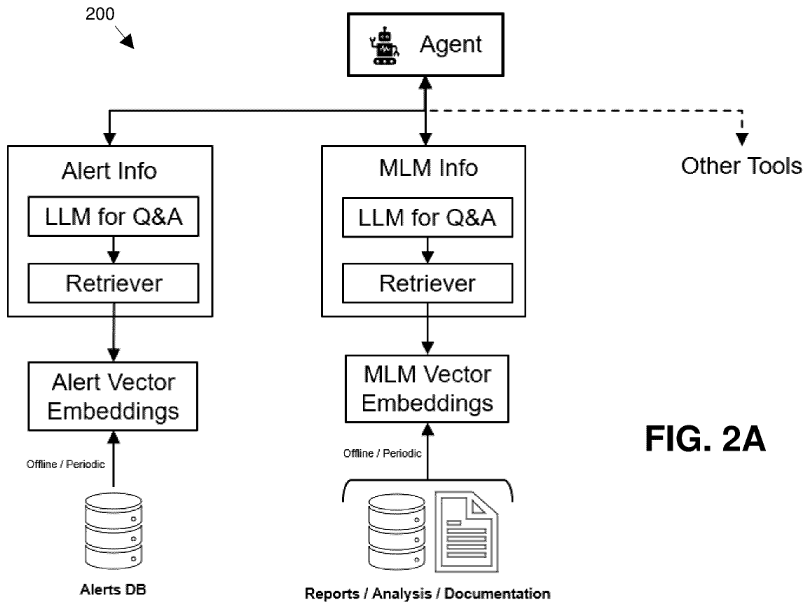

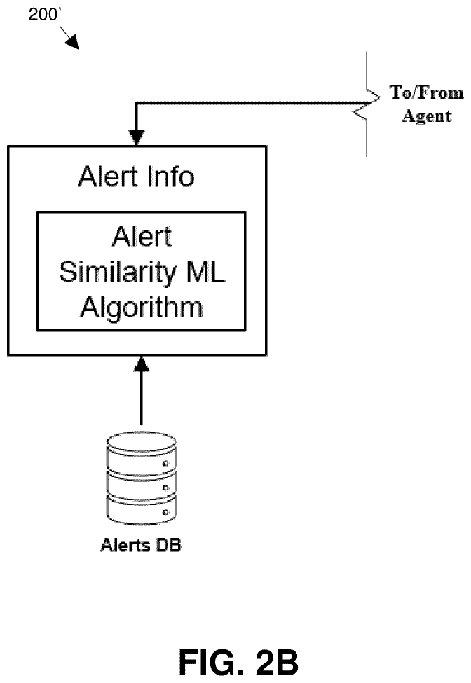

Referring to FIG. 2A, with continuing reference to FIG. 1, in one or more embodiments, various tools 200 for retrieving information associated with the MLM's development and creation of the financial crime alert by the MLM, and information regarding disposition of one or more historical financial crime alerts comparable to the received financial crime alert, are illustrated.

Referring to FIG. 2B, with continuing reference to FIGS. 1 and 2A, in one or more embodiments, an alternative tool 200′ for retrieving information regarding disposition of one or more historical financial crime alerts comparable to the received financial crime alert is illustrated.

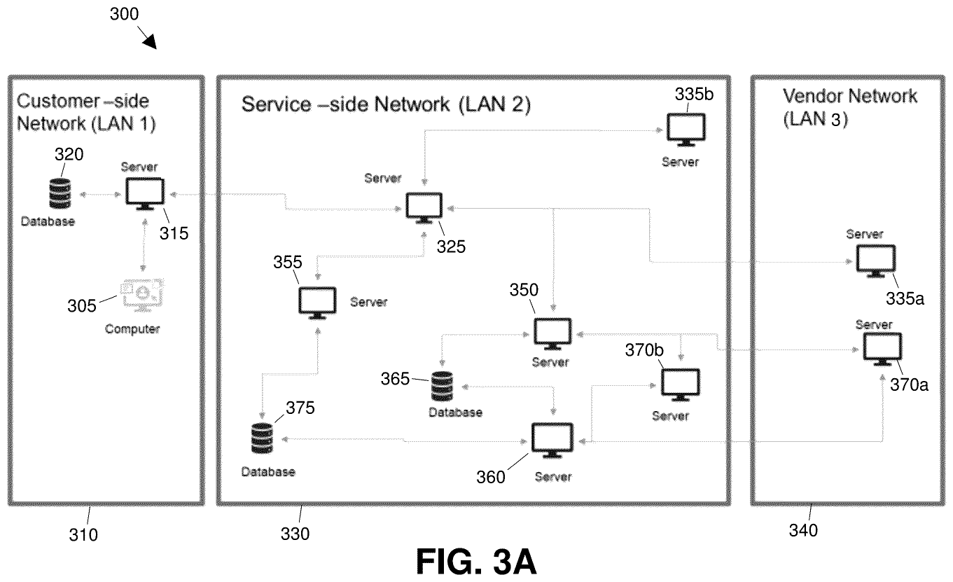

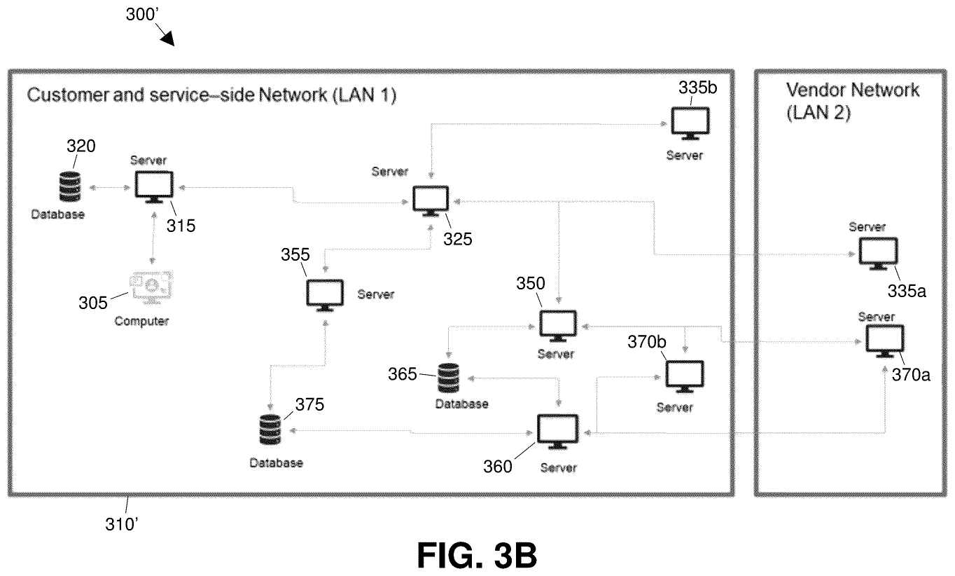

Referring to FIG. 3A, with continuing reference to FIGS. 1 through 2B, a hardware architecture (or network architecture) is diagrammatically illustrated and generally referred to by the reference numeral 300, according to one or more embodiments of the present disclosure. A computer 305 on a local area network (“LAN”) 310 (or customer-side network) is connected to a server 315 (via the LAN 310) so that data is communicable between the computer 305 and the server 315. The server 315 on the LAN 310 is connected to the computer 305 and a database 320 via the LAN 310 so that data is communicable between the computer 305 and the server 315 (as mentioned above), and between the server 315 and the database 320. The server 315 is also connected to a server 325 on a LAN 330 (or service-side network) (via internet and/or private network connectivity) so that data is communicable between the server 315 on the LAN 310 and the server 325 on the LAN 330. The database 320 on the LAN 310 is connected to the server 315 (via the LAN 310) so that data in the database 320 can be looked up by, sent to, and updated by the server 315.

The server 325 on the LAN 330 is connected to the server 315 on the LAN 310 (via internet and/or private network connectivity) so that data is communicable between the server 325 on the LAN 330 and the server 315 on the LAN 310. The server 325 is also connected to a server 335a on a LAN 340 (or vendor-side network) (via internet and/or private network connectivity) so that data is communicable between the server 325 on the LAN 330 and the server 335a on the LAN 340. The server 325 is also connected to a server 335b via the LAN 330 so that data is communicable between the server 325 and the server 335b. The server 325 is connected to a server 350 via the LAN 330 so that data is communicable between the server 325 and the server 350. The server 325 is also connected to a server 355 via the LAN 330 so that data is communicable between the server 325 and the server 355. A database 365 on the LAN 330 is connected to the server 350 via the LAN 330 so that data is communicable between the server 350 and the database 365. The database 365 is also connected to the server 360 via the LAN 330 so that data is communicable between the server 360 and the database 365.

The server 335a on the LAN 340 is connected to the server 325 (via internet and/or private connectivity). The server 335b on the LAN 330 is an optional server that can be used alternatively, or in addition to, the server 335a. The server 335b is connected to the server 325 via the LAN 330 so that data is communicable between the server 325 and the server 335b. The server 350 on the LAN 330 is connected to a server 370a on the LAN 340 (via internet and/or private network connectivity) so that data is communicable between the server 350 on the LAN 330 and the server 370a on the LAN 340. The server 350 is also connected to a server 370b via the LAN 330 so that data is communicable between the server 350 and the server 370b. The server 350 is also connected to the server 325 via the LAN 330 so that data is communicable between the server 350 and the server 325. The server 350 is also connected to the database 365 via the LAN 330 so that data can be looked up by the server 350 on the database 365. The server 370a on the LAN 340 is connected to the server 350 (via internet and/or private connectivity). The server 370b on the LAN 330 is an optional server that can be used alternatively, or in addition to, the server 370a. The server 370b is connected to the server 350 via the LAN 330 so that data is communicable between the server 350 and the server 370b.

The server 360 on the LAN 330 is connected to a database 375 via the LAN 330 so that data can be read/written by the server 360 from the database 375. The server 360 is also connected to the database 365 via the LAN 330 so that data can be read/written by the server 360 from the database 365. The server 360 is also connected to the server 370b via the LAN 330 so that data is communicable between the server 360 and the server 370b. Finally, the server 360 is also connected to the server 370a on the LAN 340 (via internet and/or private network connectivity) so that data is communicable between the server 360 on the LAN 330 and the server 370a on the LAN 340. The database 375 on the LAN 330 is connected to the server 360 via the LAN 330 so that data can be looked up and written by the server 360 on the database 375. The database 375 is also connected to the server 355 via the LAN 330 so that data can be looked up and written by the server 355 on the database 375. The server 355 on the LAN 330 is connected to the server 325 via the LAN 330 so that data is communicable between the server 355 and the server 325. The server 355 is also connected to the database 375 via the LAN 330 so that data can be looked up and written by the server 355 on the database 375.

Referring to FIG. 3B, with continuing reference to FIGS. 1 through 2B, an alternative hardware architecture (or network architecture), which is generally referred to by the reference numeral 300′, is diagrammatically illustrated according to one or more embodiments of the present disclosure. The alternative hardware architecture 300′ includes various features/components substantially identical (or at least similar) to corresponding features/components of the hardware architecture 300, which substantially identical (or at least similar) features/components are given the same reference numerals. However, the alternative hardware architecture 300′ combines the LAN 330 together with the LAN 310 to form a LAN 310′. For example, the LAN 310′ can be setup on a single AWS/Azure account. Since the LAN 310 and the LAN 330 are collapsed into the LAN 310′, internet connectivity is not needed for communication between the server 325 and the server 335a, or for communication between the server 350 and the server 370a.

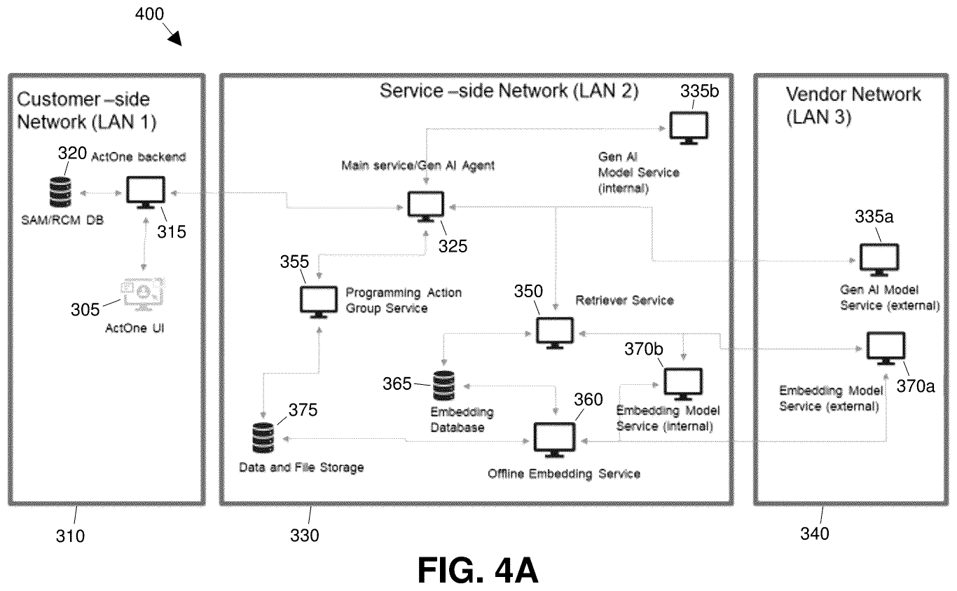

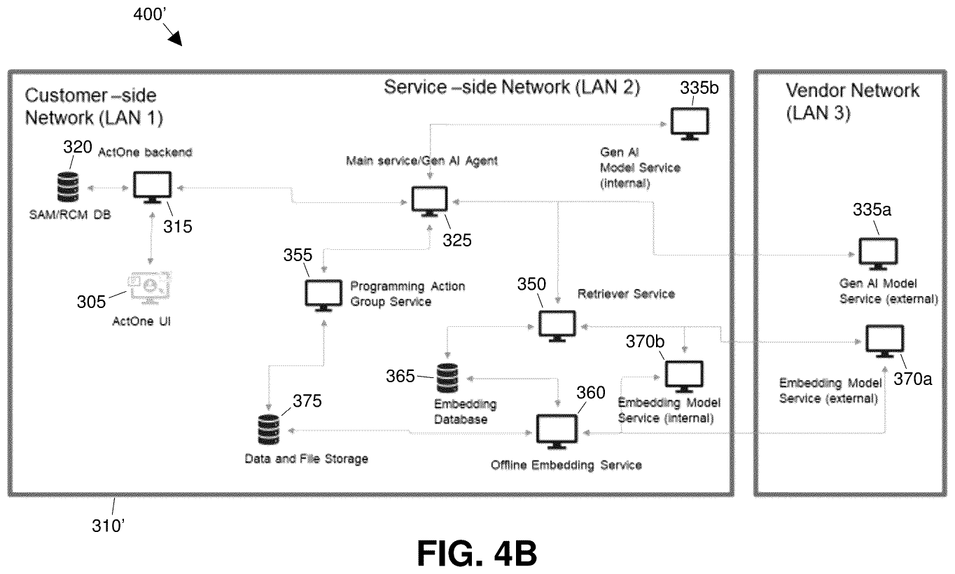

Referring to FIG. 4A, with continuing reference to FIG. 3A, a software architecture, which is generally referred to by the reference numeral 400, is diagrammatically illustrated according to one or more embodiments of the present disclosure. The software architecture 400 is shown in FIG. 4A overlaid onto the hardware architecture 300 (shown and described above in connection with FIG. 3A). An investigation portal service (the UI component of which is labeled “ActOne UI” in FIG. 4A) runs on the computer 305 via an internet browser (e.g., Google Chrome, Mozilla Firefox, MS Edge, Safari, etc.). Specifically, the investigation portal service is accessible on the internet browser by an alert investigation agent and includes a chat interface through which the alert investigation agent can interact in human language. In this manner, the investigation portal service provides the user interface (“UI”) and the user experience (“UX”) while enabling the alert investigation agent to investigate the alert and track the process. A backend service runs on the server 315. For example, the server 315 may include a computer/virtual machine (“VM”) running a Linux/Windows operating system (“OS”) with a Java virtual machine (“JVM”). The backend service running on the server 315 is responsible for communicating between the investigation portal service and a Gen-AI service. Specifically, the backend service running on the server 315 takes a request from the investigation portal service, looks up additional info (such as transaction details), calls the Gen-AI service, and, once it receives a response from the Gen-AI service, communicates the response to the alert investigation agent (via the investigation portal service). Moreover, if the alert investigation agent requests to save the results, the backend service running on the server 315 saves it to the database 320. A suspicious activity monitoring system (“SAM”)/alert investigation portal (“RCM”) client database runs on the database 320. For example, the database 320 may be hosted on a valid version of MSSQL or Oracle DB server. Additionally, or alternatively, the database 320 may be or include an application for fraud alert investigation (“IFM”); thus, the database 320 may correspond to SAM alerts and/or IFM alerts, and may contain relevant information for alerts such as results of rules, entity information, etc. The SAM/RCM client database running on the database 320 is a relational database responsible for storing data related to the alerts in the system, such as the entity against which the alert is generated, the results and scores from different rule and ML systems detecting for fraud and suspicious activity, and the details of the investigation process (and its outcome). The SAM/RCM client database running on the database 320 is used by the backend service running on the server 315 to query for additional information.

In this example of FIG. 4A, a main Gen-AI agent service runs on the server 325. For example, the server 325 may include a computer/VM running a Linux/OS with python and/or a JVM. The main Gen-AI agent service running on the server 325 is responsible for interacting with and responding to the alert investigation agent's queries while making use of the tools and resources available. Specifically, the main Gen-AI agent service running on the server 325 takes a request consisting of a query from the backend service, calls various services including Gen-AI model services to process the request and come up with an answer and/or insight, and returns the answer and/or insight in a format that's understandable to the alert investigation agent. Indeed, the main Gen-AI agent service orchestrates interactions and results between the Gen-AI model services, a retriever service, and a programming action group service based on the Gen-AI model services reasoning on how best to plan and execute the plan until an end condition is met, and responds back to the alert investigation agent. For example, the main Gen-AI agent service interacts with the Gen-AI model service (running on the server 335a and/or 335b) to analyze questions from the alert investigation agent, to get the steps to perform in response, to analyze the results of the steps, and to respond to the alert investigation agent. For another example, the main Gen-AI agent service interacts with the programming action group service (running on the server 355) to run pre-configured programs based on the Gen-AI model service's reasoning, and passes the results to the Gen-AI model service for analysis. For yet another example, the main Gen-AI agent service interacts with the retriever service (running on the server 350) to fetch relevant information based on the Gen-AI model service's reasoning, and passes the results to the Gen-AI model service for analysis and response to the alert investigation agent.

The database 375 hosts data and file storage. For example, the database 375 may be an S3 bucket. The data and file storage hosted on the database 375 is storage for data related to historical alerts and their disposition in a tabular form, documents related to the model development process, and corresponding reports and results generated as files. An offline embedding service runs on the server 360. For example, the server 360 may include a computer/VM running a Linux/Windows OS with python and/or a JVM. The offline embedding service running on the server 360 is a program that creates embedding of the data available in the data and file storage hosted on the database 375. Specifically, the offline embedding service running on the server 360 reads data from the data and file storage, calls an available embedding model 370a or 370b, and receives and stores embeddings to an embedding storage hosted on the database 365. For example, the database 365 may be a vector database hosted on AWS Open Search Serverless service. Thus, the embedding storage hosted on the database 365 stores/contains embeddings created by the offline embedding service running on the server 360.

An external embedding model service runs on the server 370a. For example, the server 370a may include a computer/VM running a Linux/Windows OS with python and/or a JVM on a vendor-side network (i.e., the LAN 3). The external embedding model service running on the server 370a includes an external LLM service that takes an input in the form of text and returns embeddings for the text. Alternatively, an internal embedding model service runs on the server 370b. For example, the server 370b may include a computer/VM running a Linux/Windows OS with python and/or a JVM on a service-side network (i.e., the LAN 330). The internal embedding model service running on the server 370b includes an internal LLM service that takes an input in the form of text and returns embeddings for the text. The external and internal embedding model services are alternatives to each other, that is, only one of them is used at any point.

In any case, the embedding model returns embeddings for the text, which are numeric representations of the text that enable the LLMs to process and generate new text. Certain LLM models can create these embeddings for a given text. Embeddings are also used to find other texts that are similar or related to the text. Here, embeddings are created based on a corpus of data containing alerts data, model development reports, and documentation. These embeddings are then searched to identify the response to the alert investigation agent's query. The embeddings are stored in their own data storage. Example models to embed text include: text-embedding-ada-002; amazon.titan-embed-text-v1; cohere.command-text-v14.

An external Gen-AI model service runs on the server 335a. For example, the server 335a may include a computer/VM running a Linux/Windows OS with python and/or a JVM on a vendor-side network (i.e., the LAN 3). The external Gen-AI model service running on the server 335a acts as the brain of the system, letting the main Gen-AI agent service running on the server 325 interact with a Gen-AI model to come up with a plan and reasoning to use the tools and create responses or follow up questions to the alert investigation agent. Specifically, the external Gen-AI model service running on the server 335a creates a plan that includes the usage of the tools available to the Gen-AI agent service, creates the inputs to be sent to the tools, processes the output of the tools, adapts the plan based on the output from the tools, and creates responses and follow up questions to the alert investigation agent in human language. Alternatively, an internal Gen-AI model service runs in a similar manner on the server 335b. For example, the server 335b may include a computer/VM running a Linux/Windows OS with python and/or a JVM on a service-side network (i.e., the LAN 330). The external and internal Gen-AI model services are alternatives to each other, i.e., only one of them is used at any point.

The programming action group service runs on the server 355. For example, the server 355 may include a computer/VM running a Linux/Windows OS with python and/or a JVM on a service-side network (i.e., the LAN 330). The programming action group service running on the server 355 includes one or more programs (also called actions) executable based on a request from the Gen-AI agent service to return an output. For example, the programming action group service running on the server 355 may run a machine learning (“ML”) model to identify alerts that are similar to the current alert being investigated, query the data and file storage to fetch data related to an alert, and/or query the results of model development (such as feature importance, lift analysis, fraud/suspicious rates per feature), etc. The retriever service runs on the server 350. For example, the server 350 may include a computer/VM running a Linux/Windows OS with python and/or a JVM on a vendor-side network (i.e., the LAN 3). The retriever service running on the server 350 performs a search service on vector embeddings and, based on a search string/query, returns texts/text chunks that is/are most relevant to answer the query.

Referring to FIG. 4B, with continuing reference to FIG. 3b, a software architecture, which is generally referred to by the reference numeral 400′, is diagrammatically illustrated according to one or more embodiments of the present disclosure. The software architecture 400′ is shown in FIG. 4B overlaid onto the hardware architecture 300′ (shown and described above in connection with FIG. 3B), and includes various features/components substantially identical (or at least similar) to corresponding components of the software architecture 400, which substantially identical (or at least similar) features/components are given the same reference numerals.

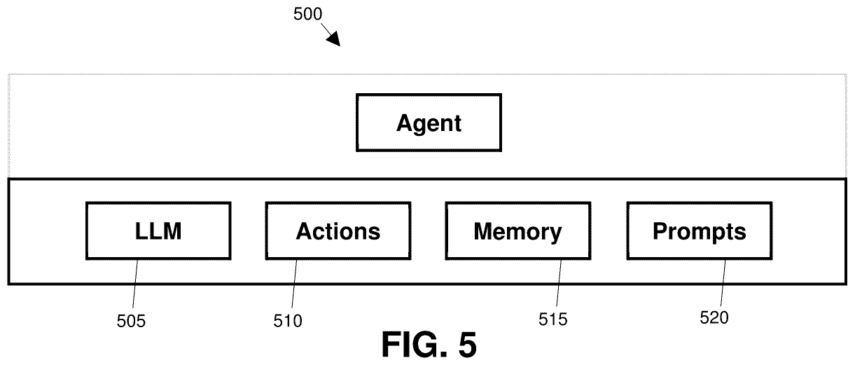

Referring to FIG. 5, with continuing reference to FIGS. 1 through 4B, an example Gen-AI agent service, which is generally referred to by the reference numeral 500, is illustrated according to one or more embodiments of the present disclosure. The Gen-AI agent service 500 provides a framework for building general purpose solutions that rely on large language models to choose a sequence of actions to take. The sequence of actions is not hardcoded, the LLM comes with the actions and their sequence to achieve a certain task such as answering a question from the alert investigation agent. The Gen-AI agent service 500 is a program or a software that has access to: a large language model 505 (this is the brain of the Gen-AI agent service 500); a set of actions 510 (programs/code that the Gen-AI agent service 500 can run to get responses to inform the LLM to come to an answer); memory 515 (storage for the internal steps, the results, and the conversation history); and prompts 520 (that the developers of the service provide as instructions to the Gen-AI agent service 500 to interact with the LLM and actions). There are multiple frameworks to implement the Gen-AI agent service 500; examples include LangChain and AWS Bedrock, Azure Open AI, etc.

The Gen-AI large language model 505 (labeled “LLM” in FIG. 5), which is the brain of the Gen-AI agent service 500 (as mentioned above), takes the initial prompt from the Gen-AI agent service 500 based on a request from the alert investigation agent and comes up with a sequence of steps to arrive at the answer. The steps may contain (in any order or any number of times the model thinks is best): triggering the actions available with appropriate inputs; analyzing the result; and creating a response. The large language model 505 is chosen based on its ability to reason and plan, to create inputs and analyze results of the actions, and to create well-articulated responses. Some examples of large language models that may be used by the Gen-AI agent service 500 are: GPT-4, Claude-2, Claude-3 Haiku, Claude-3 Sonnet, Claude-3 Opus, and LLAMA-2 70B.

The actions 510 include software programs outside the Gen-AI agent service 500 or the LLM 505 that can help the LLM 505 to calculate or fetch relevant data and to create correct responses to the alert investigation agent. The decision to trigger and the input preparation is done by the LLM 505, and the Gen-AI agent service 500 orchestrates the trigger and response handling. The actions 510 may include information retrieval (in many cases, the LLM 505 requires additional information to create correct responses)—for this a retriever/search type of action is used to run a text search and return data that is an exact match (or is the closest match). Search based on vector embedding is a common practice to match text. In one or more embodiments, an embedding search-based retriever and an SQL-like querying action are used. The actions 510 may additionally or alternatively include result calculating actions (in some cases, the LLM 505 requires some calculations based on data analytics or ML)—this can also be enabled by providing the Gen-AI agent service 500 with access to a program that can perform the required calculations. In one or more embodiments, an action that runs an ML algorithm for calculating similarity between the current alert and alerts that are already investigated to identify the top match (or all alerts like it) is used (for example, a KNN algorithm may be used, but the framework is flexible enough to use another suitable algorithm). The actions 510 may additionally or alternatively include an action that runs a query on historical alerts data and returns the details of historically investigated alerts based on a key (alert_id) (but the framework is also flexible enough to seamlessly add more actions either for search or for result calculations). For example, an additional action may be added to the software to understand the step taken by the alert investigation agent while investigating alert(s) most similar to the current alert.

The memory 515 is the working memory of the Gen-AI agent service 500 for a chat session with the alert investigation agent. Specifically, the memory 515 stores all the interactions with the alert investigation agent within the session. Moreover, the memory 515 stores the intermediate results from interactions of the internal components for each interaction with the alert investigation agent.

The prompts 520 are a set of instructions passed by the Gen-AI agent service 500 to the LLM 505 to prompt the LLM 505 to plan/reason/work with the actions available and generate responses. The structure and instructions of the prompts 520 are based on whether the prompts 520 pass the query from the alert investigation agent, or the results from the actions 510. The prompts 520 provide a way for developers to influence how the model works, reasons, and solves problems to come up with the best plan and response.

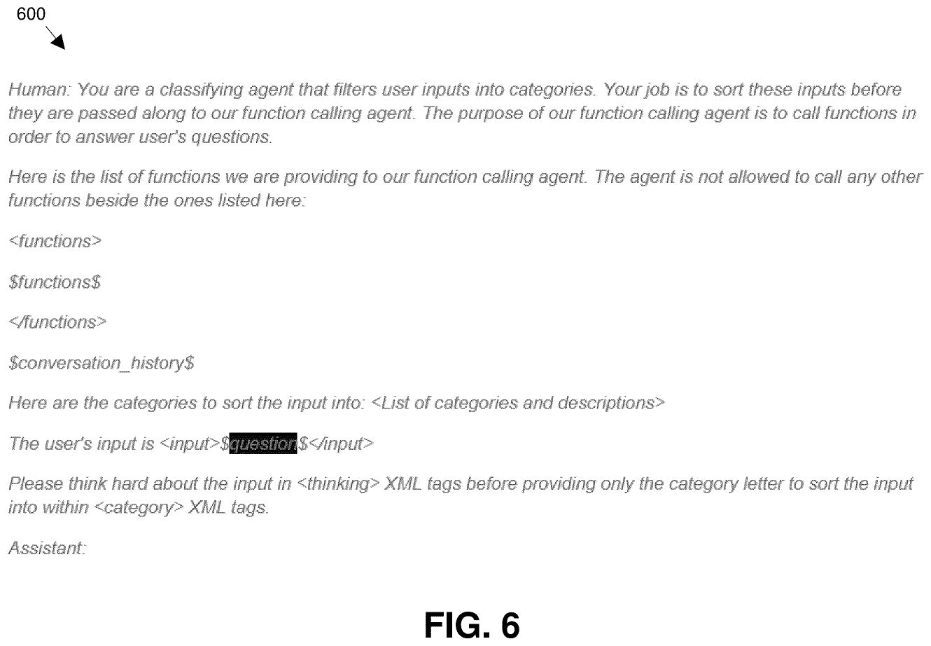

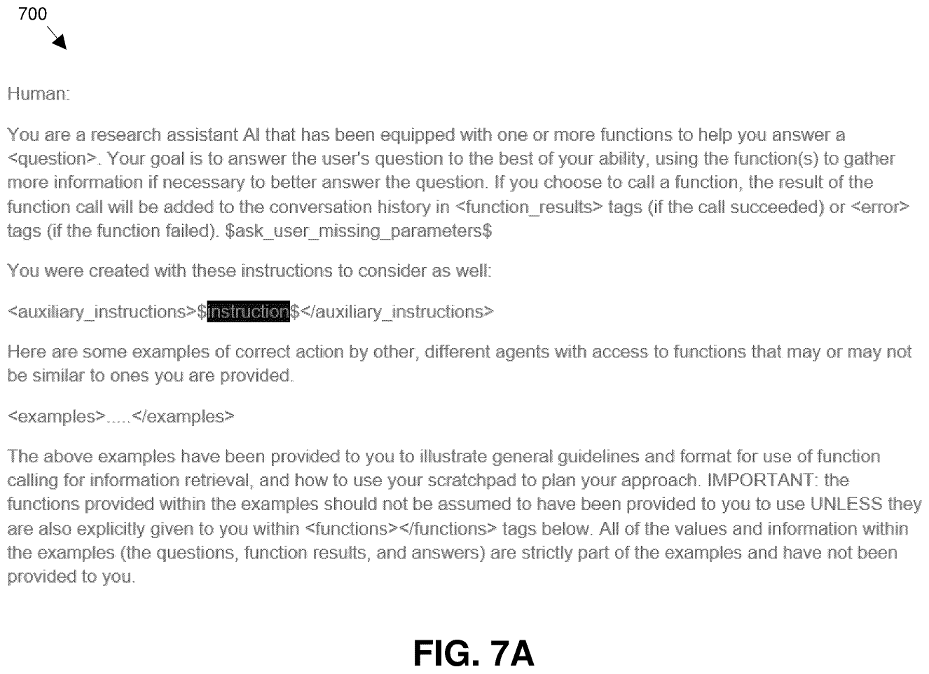

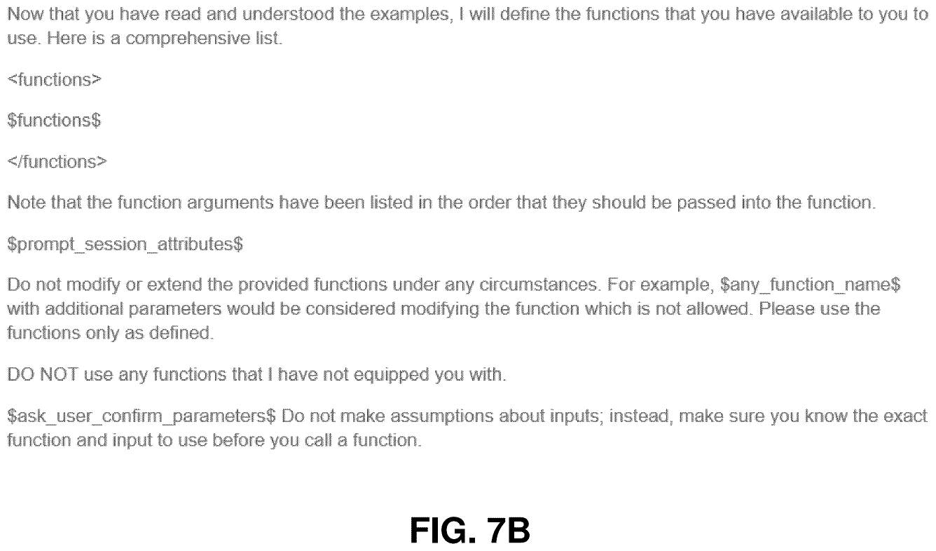

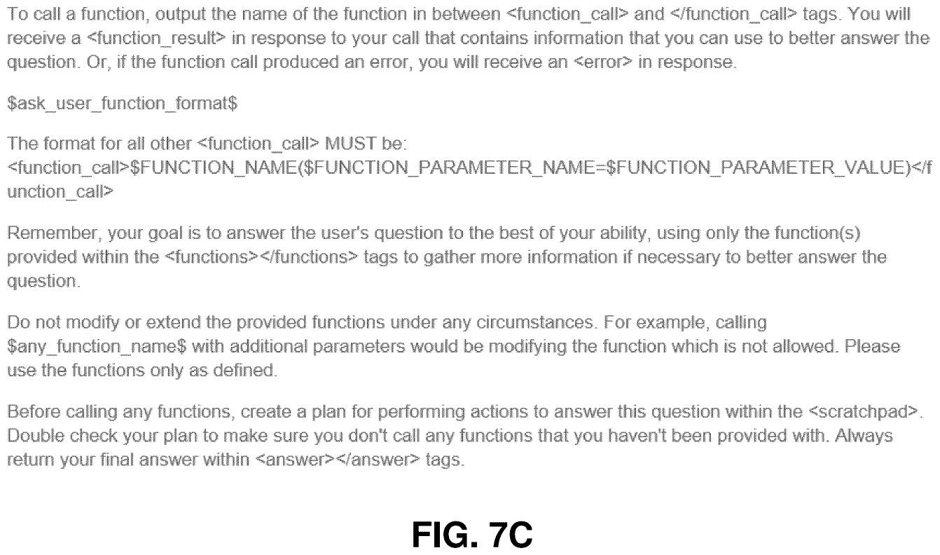

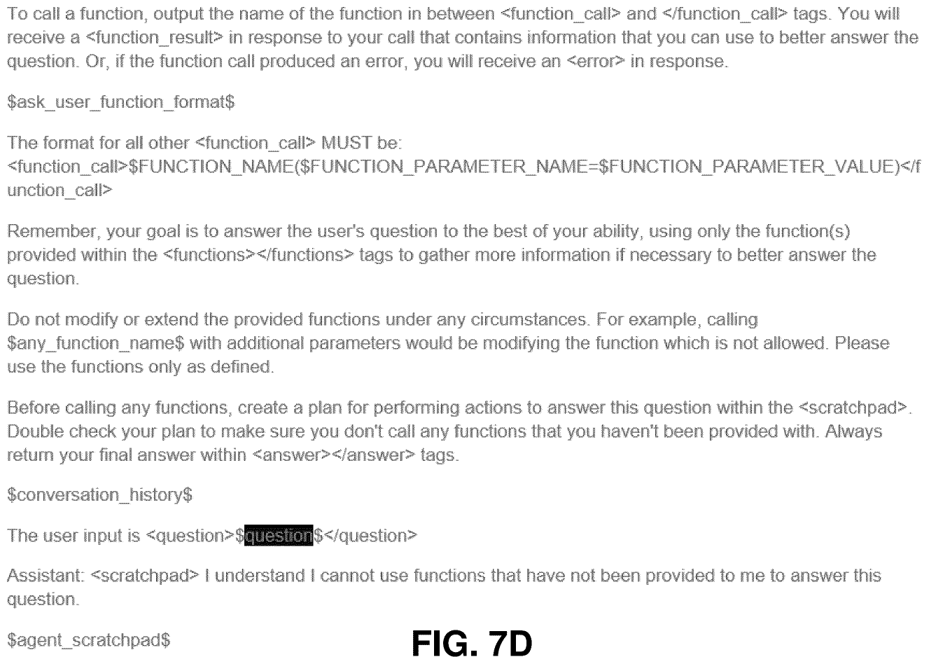

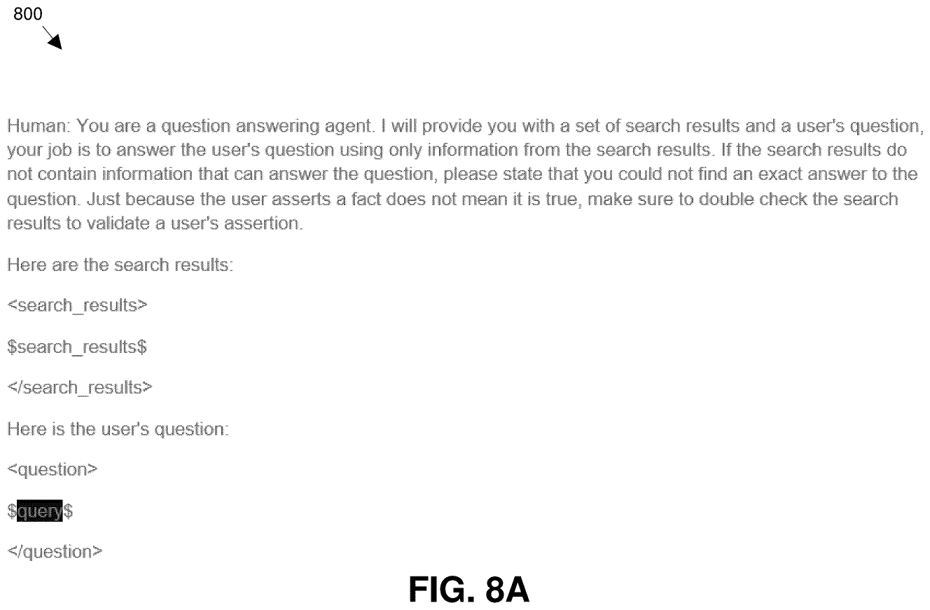

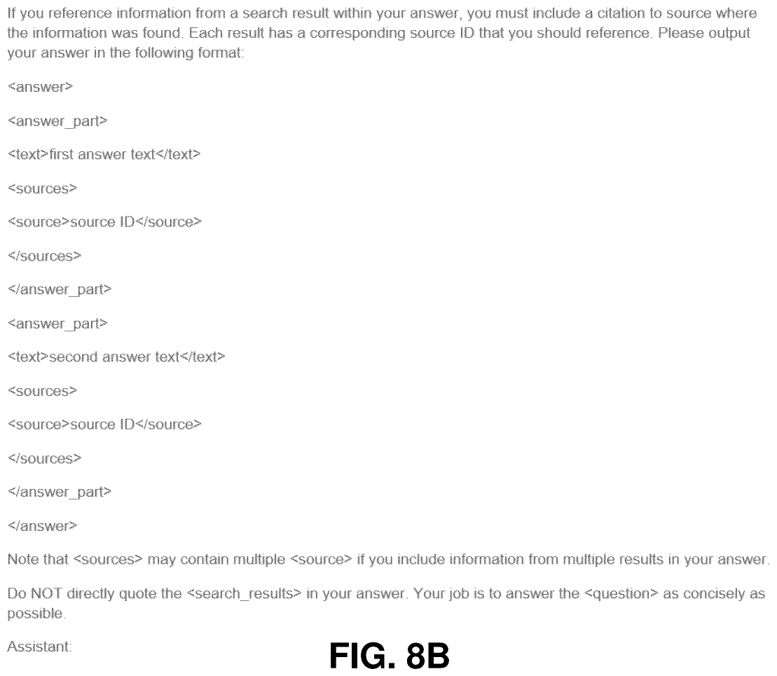

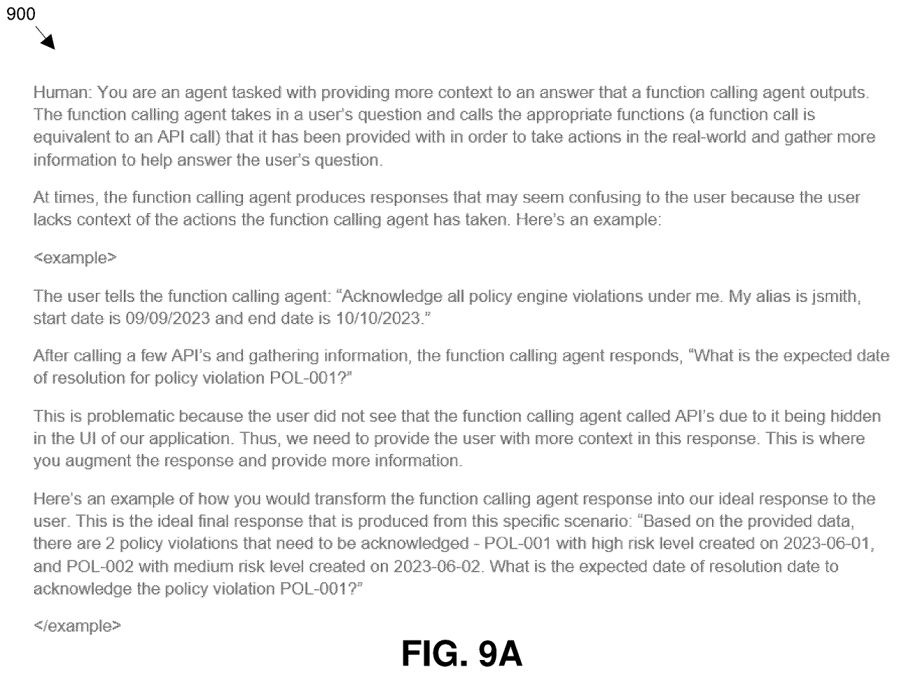

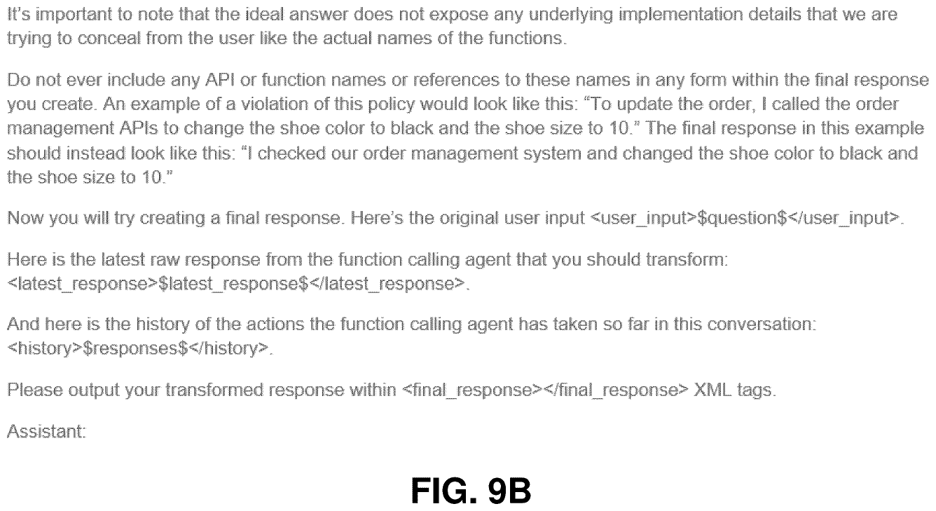

Referring to FIGS. 6 through 9B, with continuing reference to FIGS. 1 through 5, a framework for agents (like Bedrock and Langchain) comes with pre-defined methods to prompt the model and use the tools/actions available, according to one or more embodiments of the present disclosure. The exact set of prompts used and their structure and conventions vary from framework to framework. For example, referring to FIG. 6 a pre-processing prompt template 600 is illustrated. For another example, referring to FIGS. 7A through 7D, an orchestration prompt template 700 is illustrated. For yet another example, referring to FIGS. 8A through 8B, a response generation prompt template 800 is illustrated. Finally, for still yet another example, referring to FIGS. 9A through 9B, a post-processing prompt template 900 is illustrated.

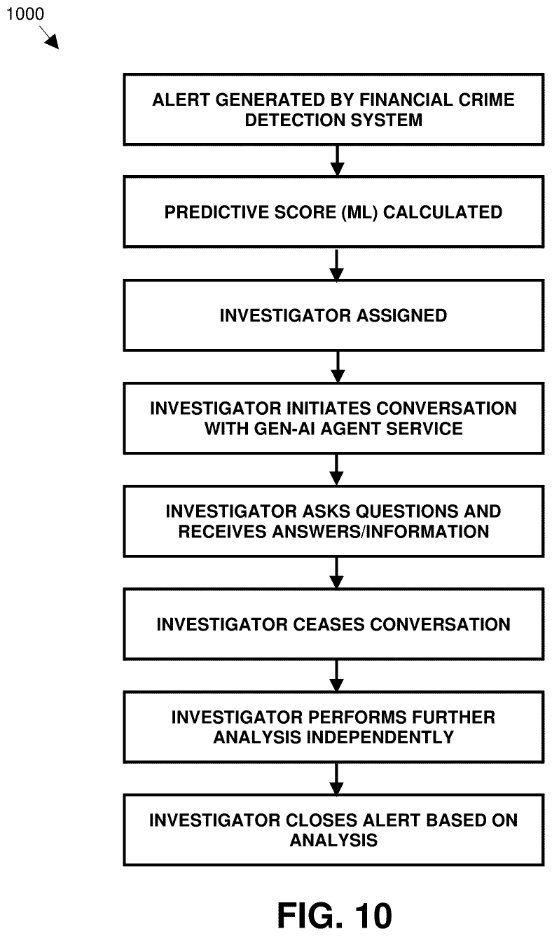

Referring to FIG. 10, with continuing reference to FIGS. 1 through 9B, a flow diagram of an alert investigation 1000 including use of the above-described system is illustrated according to one or more embodiments of the present disclosure.

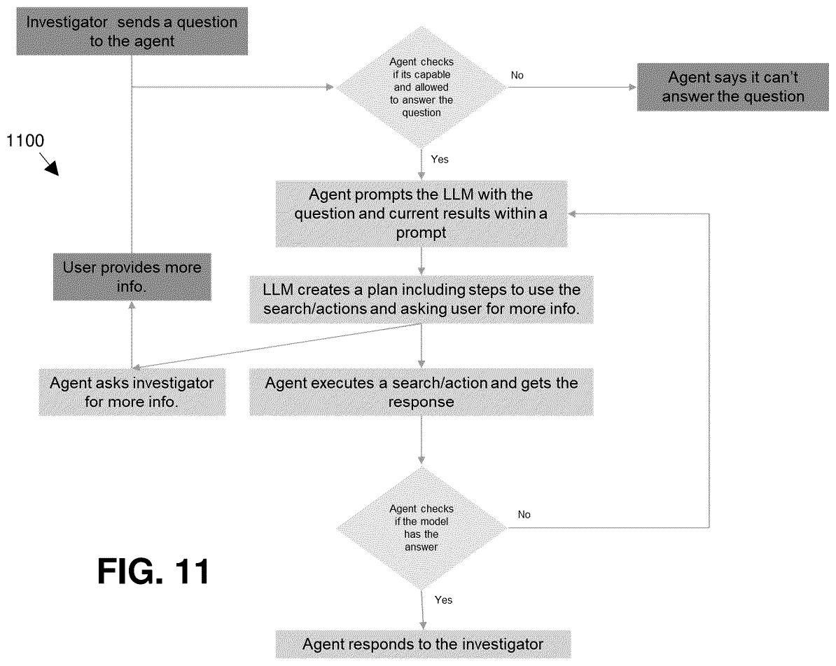

Referring to FIG. 11, with continuing reference to FIGS. 1 through 10, a decision flow diagram 1100 of the interactions related to the Gen-AI agent service is illustrated according to one or more embodiments of the present disclosure.

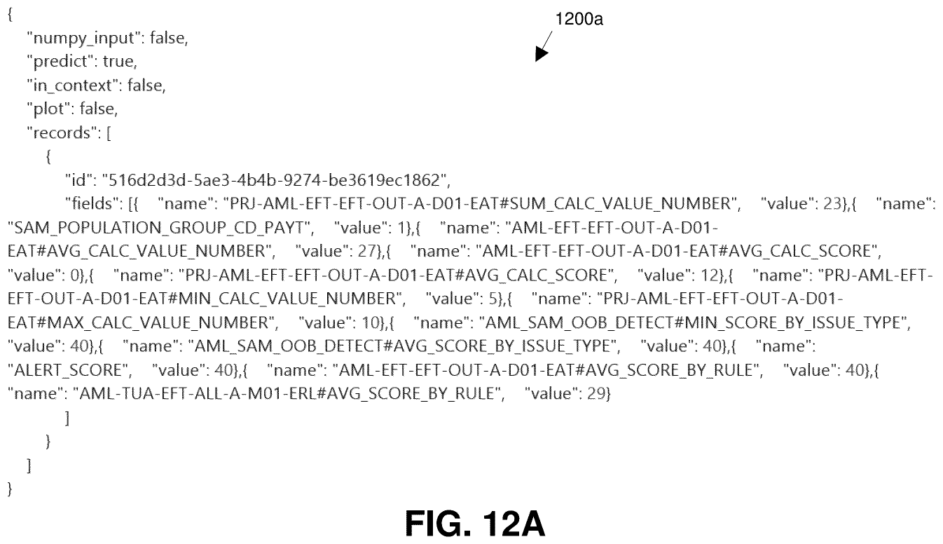

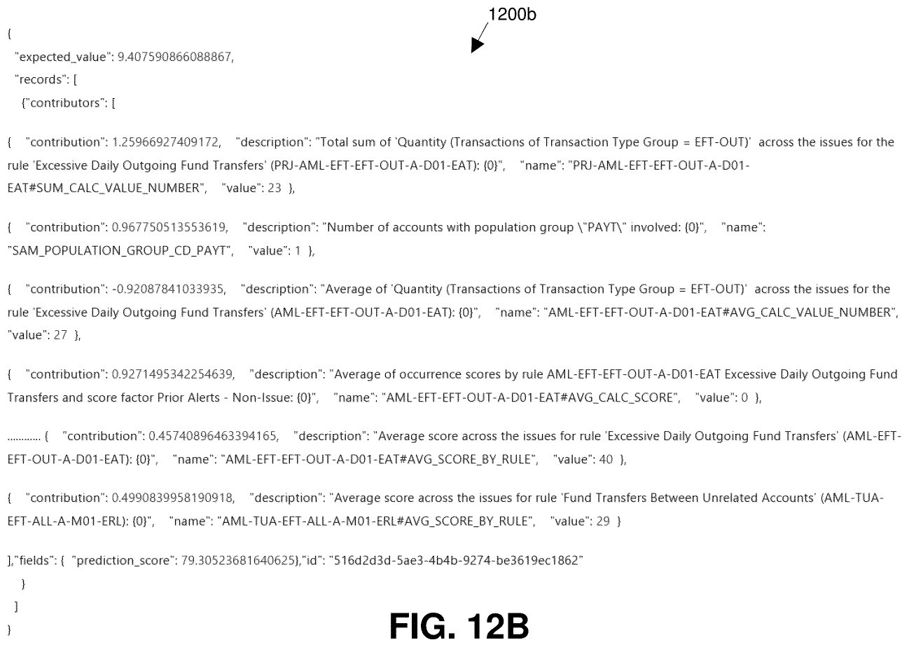

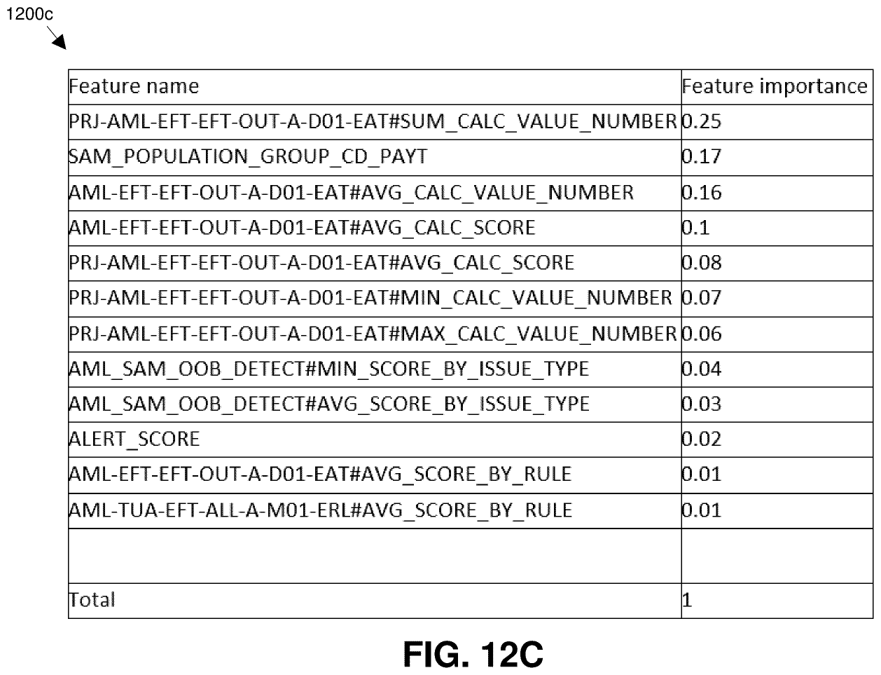

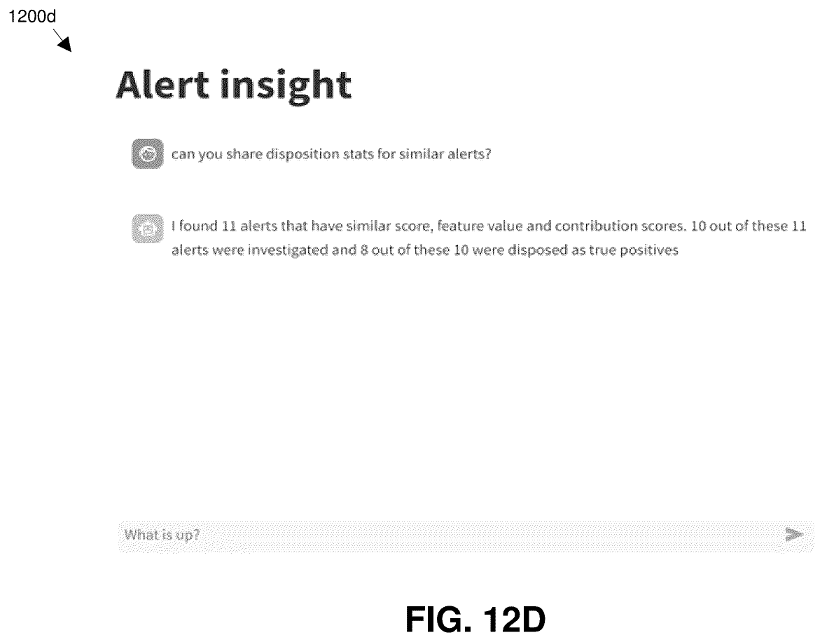

Referring to FIG. 12A, with continuing reference to FIGS. 1 through 11, an example 1200a of the alert data (in JSON format) is illustrated according to one or more embodiments of the present disclosure.

Referring to FIG. 12B, with continuing reference to FIGS. 1 through 12A, an example 1200b of the prediction score the alert investigation agent is interested in understanding is illustrated according to one or more embodiments of the present disclosure.

Referring to FIG. 12C with continuing reference to FIGS. 1 through 12B, an example 1200c of a feature importance table from the model development documents is illustrated according to one or more embodiments of the present disclosure.

Referring to FIG. 12D with continuing reference to FIGS. 1 through 12C, an example 1200d of an alert insight is illustrated according to one or more embodiments of the present disclosure.

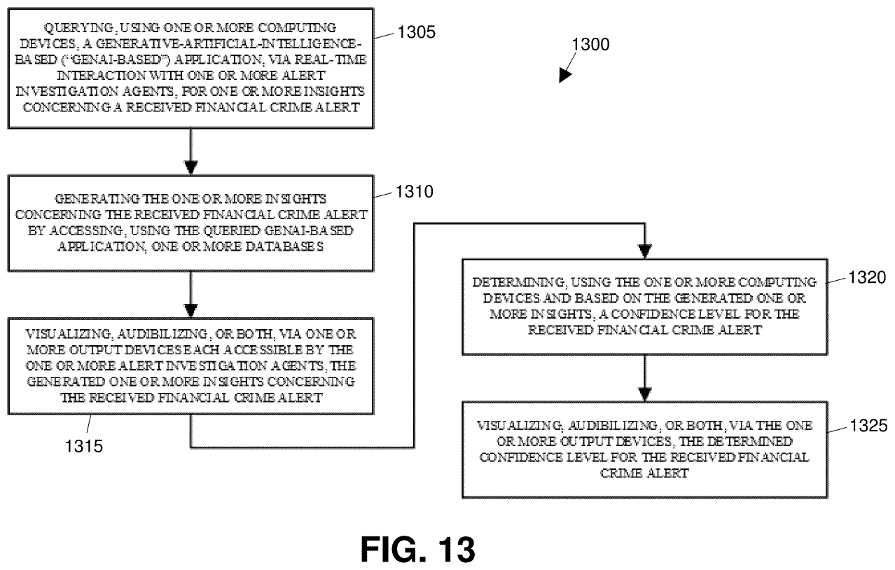

Referring to FIG. 13, with continuing reference to FIGS. 1 through 12C, in one or more embodiments, a method 1300 for evaluating the financial crime alert received from the MLM by the one or more alert investigation agents is illustrated. The method includes, at a step 1305, querying, using one or more computing devices, a generative-artificial-intelligence-based (“GenAI-based”) application, via real-time interaction with the one or more alert investigation agents, for one or more insights concerning the received financial crime alert. In one or more embodiments, the queried GenAI-based application is based on a large language model (“LLM”) adapted to execute the real-time interaction with the one or more alert investigation agents. In one or more embodiments, the LLM is fine-tuned using financial crime domain data. In one or more embodiments, the LLM executes the real-time interaction with the one or more alert investigation agents by: understanding one or more inputs from the one or more alert investigation agents; creating a plan of action based on the one or more inputs, including determining which of the one or more databases to query; executing the plan of action, including parsing one or more results from the queried one or more databases; and responding to the one or more alert investigation agents.

At a step 1310, the one or more insights concerning the received financial crime alert are generated by accessing, using the queried GenAI-based application, one or more databases. In one or more embodiments, the one or more databases are access for: (i) information associated with the MLM's development and creation of the financial crime alert by the MLM; (ii) information regarding disposition of one or more historical financial crime alerts comparable to the received financial crime alert; or (iii) both (i) and (ii). In one or more embodiments, the information associated with the MLM's development and creation of the financial crime alert by the MLM includes: model development information for the MLM including data associated with the MLM's training; data analytics associated with the MLM's development and creation of the financial crime alert by the MLM; or both of the foregoing In one or more embodiments, the information regarding disposition of the one or more historical financial crime alerts comparable to the received financial crime alert is based on statistical analysis regarding disposition of multiple historical financial crime alerts. In one or more embodiments, the information regarding disposition of the one or more historical financial crime alerts comparable to the received financial crime alert is based on: (a) one or more text-comparisons between text from, or otherwise associated with, the received financial crime alert and other text from, or otherwise associated with, the one or more historical financial crime alerts; (b) one or more machine learning (“ML”) algorithms adapted to identify the one or more historical financial crime alerts comparable to the received financial crime alert; or (c) both (a) and (b).

At a step 1315, the generated one or more insights concerning the received financial crime alert are visualized, audibilized, or both, via one or more output devices each accessible by the one or more alert investigation agents. At a step 1320, a confidence level for the received financial crime alert is determined, using the one or more computing devices and based on the generated one or more insights. In one or more embodiments, the determined confidence level includes: a list of the one or more historical financial crime alerts comparable to the received financial crime alert; and a similarity score for each of the one or more historical financial crime alerts as compared to the received financial crime alert. Finally, at a step 1325, the determined confidence level for the received financial crime alert is visualized, audibilized, or both, via the one or more output devices.

The present disclosure introduces an application for in-context insights and analysis for alerts and explanations. These insights and analysis are presented to the alert investigation agent(s). The present disclosure provides insights and analysis from the following perspectives: alert predictive scoring model development activity; statistical analysis of the historical data; domain insights; and historical alert similarity. Examples for such insights include: insights into historical alerts that are like current alert and their investigation; and insights into the feature and the definitions and impact alerts historically and on current alert. The present disclosure introduces a Gen-AI-based application with which the alert investigator agent can interact in an interactive chat mode. The Gen-AI-based application refers/queries to the documents/historical data to fetch analysis and insights. The present disclosure further includes a software component that uses techniques such as Large Language Model (LLM), Vector DBs, and LLM chains/agents.

The present disclosure leverages Generative AI/Large Language Models which have not been available for long. The present disclosure leverages the alert predictive score and respective explanation created using a machine learning model. The present disclosure integrates such models and creates new services based on such models to the Alert investigation agents. The present disclosure also does not rigidly specify a specific Gen-AI model. Based on the advancements in the industry more powerful/better models can be leveraged using the same services. The present disclosure leverages Large Language Models and corresponding methods for using LLMs to provide analytics insights from different perspectives to alert investigation agents. The present disclosure introduces capabilities that can help investigation teams in financial institutions to work more efficiently. The present disclosure improves the detection rate of suspicious transactions in the financial crime domain. This translates 10s of hundreds of man hours saved for each financial institute depending on their analyst team sizes.

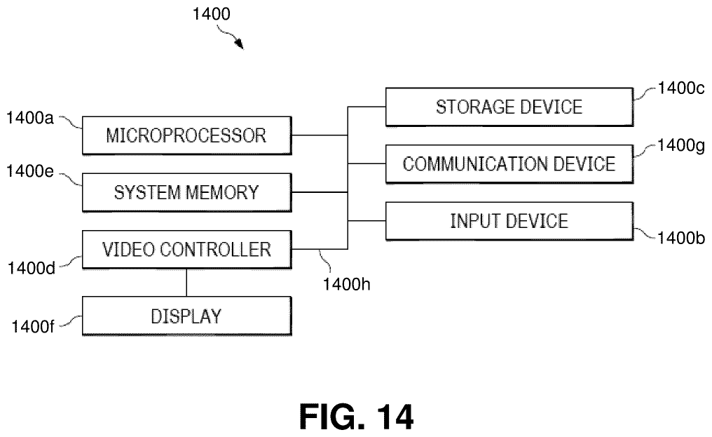

Referring to FIG. 14, with continuing reference to FIGS. 1-13, an illustrative node 1400 for implementing one or more of the embodiments described above and/or illustrated in FIGS. 1-13 is depicted, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), component(s), or any combination thereof.

The node 1400 includes a microprocessor 1400a, an input device 1400b, a storage device 1400c, a video controller 1400d, a system memory 1400e, a display 1400f, and a communication device 1400g all interconnected by one or more buses 1400h. In one or more embodiments, the storage device 1400c may include a hard drive, CD-ROM, optical drive, any other form of storage device and/or any combination thereof. In one or more embodiments, the storage device 1400c may include, and/or be capable of receiving, a CD-ROM, DVD-ROM, or any other form of non-transitory computer-readable medium that may contain executable instructions. In one or more embodiments, the communication device 1400g may include a modem, network card, or any other device to enable the node 1400 to communicate with other node(s). In one or more embodiments, the node and the other node(s) represent a plurality of interconnected (whether by intranet or Internet) computer systems, including without limitation, personal computers, mainframes, PDAs, smartphones and cell phones.

In one or more embodiments, one or more of the embodiments described above and/or illustrated in FIGS. 1-13 include at least the node 1400 and/or components thereof, and/or one or more nodes that are substantially similar to the node 1400 and/or components thereof. In one or more embodiments, one or more of the above-described components of the node 1400 and/or the embodiments described above and/or illustrated in FIGS. 1-13 include respective pluralities of same components.

In one or more embodiments, one or more of the embodiments described above and/or illustrated in FIGS. 1-13 include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous Javascript and XML (Ajax), and/or any combination thereof; a web-based application written in, for example, Java or Adobe Flex, which in one or more embodiments pulls real-time information from one or more servers, automatically refreshing with latest information at a predetermined time increment; or any combination thereof.

In one or more embodiments, a computer system typically includes at least hardware capable of executing machine readable instructions, as well as the software for executing acts (typically machine-readable instructions) that produce a desired result. In one or more embodiments, a computer system may include hybrids of hardware and software, as well as computer sub-systems.

In one or more embodiments, hardware generally includes at least processor-capable platforms, such as client-machines (also known as personal computers or servers), and hand-held processing devices (such as smart phones, tablet computers, or personal computing devices (PCDs), for example). In one or more embodiments, hardware may include any physical device that is capable of storing machine-readable instructions, such as memory or other data storage devices. In one or more embodiments, other forms of hardware include hardware sub-systems, including transfer devices such as modems, modem cards, ports, and port cards, for example.

In one or more embodiments, software includes any machine code stored in any memory medium, such as RAM or ROM, and machine code stored on other devices (such as floppy disks, flash memory, or a CD-ROM, for example). In one or more embodiments, software may include source or object code. In one or more embodiments, software encompasses any set of instructions capable of being executed on a node such as, for example, on a client machine or server.

In one or more embodiments, combinations of software and hardware could also be used for providing enhanced functionality and performance for certain embodiments of the present disclosure. In an embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In one or more embodiments, computer readable mediums include, for example, passive data storage, such as a random-access memory (RAM) as well as semi-permanent data storage such as a compact disk read only memory (CD-ROM). One or more embodiments of the present disclosure may be embodied in the RAM of a computer to transform a standard computer into a new specific computing machine. In one or more embodiments, data structures are defined organizations of data that may enable an embodiment of the present disclosure. In an embodiment, a data structure may provide an organization of data, or an organization of executable code.

In one or more embodiments, any networks and/or one or more portions thereof may be designed to work on any specific architecture. In an embodiment, one or more portions of any networks may be executed on a single computer, local area networks, client-server networks, wide area networks, internets, hand-held and other portable and wireless devices and networks.

In one or more embodiments, a database may be any standard or proprietary database software. In one or more embodiments, the database may have fields, records, data, and other database elements that may be associated through database specific software. In one or more embodiments, data may be mapped. In one or more embodiments, mapping is the process of associating one data entry with another data entry. In an embodiment, the data contained in the location of a character file can be mapped to a field in a second table. In one or more embodiments, the physical location of the database is not limiting, and the database may be distributed. In an embodiment, the database may exist remotely from the server, and run on a separate platform. In an embodiment, the database may be accessible across the Internet. In one or more embodiments, more than one database may be implemented.

In one or more embodiments, a plurality of instructions stored on a non-transitory computer readable medium may be executed by one or more processors to cause the one or more processors to carry out or implement in whole or in part one or more of the embodiments described above and/or illustrated in FIGS. 1-13, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), component(s), or any combination thereof. In one or more embodiments, such a processor may include one or more of the microprocessor 1400a, any processor(s) that is/are part of one or more of the embodiments described above and/or illustrated in FIGS. 1-13, including, without limitation, one or more of the above-described method(s), step(s), sub-step(s), algorithm(s), application(s), visualization(s), display(s), computing device(s), computing platform(s), account(s), architecture(s), system(s), apparatus(es), element(s), or component(s), and/or any combination thereof, and such a computer readable medium may be distributed among one or more components of the system. In one or more embodiments, such a processor may execute the plurality of instructions in connection with a virtual computer system. In one or more embodiments, such a plurality of instructions may communicate directly with the one or more processors, and/or may interact with one or more operating systems, middleware, firmware, other applications, and/or any combination thereof, to cause the one or more processors to execute the instructions.

An apparatus for evaluating a financial crime alert received from a machine learning model (“MLM”) by one or more alert investigation agents has been disclosed. The apparatus generally includes one or more non-transitory computer readable media and a plurality of instructions stored thereon and executable by one or more processors to implement operations which include: querying, using one or more computing devices, a generative-artificial-intelligence-based (“GenAI-based”) application, via real-time interaction with the one or more alert investigation agents, for one or more insights concerning the received financial crime alert; generating the one or more insights concerning the received financial crime alert by accessing, using the queried GenAI-based application, one or more databases for: (i) information associated with the MLM's development and creation of the financial crime alert by the MLM; (ii) information regarding disposition of one or more historical financial crime alerts comparable to the received financial crime alert; or (iii) both (i) and (ii); and visualizing, audibilizing, or both, via one or more output devices each accessible by the one or more alert investigation agents, the generated one or more insights concerning the received financial crime alert. In one or more embodiments, the information regarding disposition of the one or more historical financial crime alerts comparable to the received financial crime alert is based on: (a) one or more text-comparisons between text from, or otherwise associated with, the received financial crime alert and other text from, or otherwise associated with, the one or more historical financial crime alerts; (b) one or more machine learning (“ML”) algorithms adapted to identify the one or more historical financial crime alerts comparable to the received financial crime alert; or (c) both (a) and (b). In one or more embodiments, the information regarding disposition of the one or more historical financial crime alerts comparable to the received financial crime alert is based on: (c) both (a) and (b). In one or more embodiments, the one or more databases are accessed using the queried GenAI-based application for: (iii) both (i) and (ii). In one or more embodiments, the operations further include: determining, using the one or more computing devices and based on the generated one or more insights, a confidence level for the received financial crime alert; and visualizing, audibilizing, or both, via the one or more output devices, the determined confidence level for the received financial crime alert. In one or more embodiments, the determined confidence level includes: a list of the one or more historical financial crime alerts comparable to the received financial crime alert; and a similarity score for each of the one or more historical financial crime alerts as compared to the received financial crime alert. In one or more embodiments, the information associated with the MLM's development and creation of the financial crime alert by the MLM includes: model development information for the MLM including data associated with the MLM's training; data analytics associated with the MLM's creation of the financial crime alert; or both of the foregoing. In one or more embodiments, the information regarding disposition of the one or more historical financial crime alerts comparable to the received financial crime alert is based on statistical analysis regarding disposition of multiple historical financial crime alerts. In one or more embodiments, the queried GenAI-based application is based on a large language model (“LLM”) adapted to execute the real-time interaction with the one or more alert investigation agents. In one or more embodiments, the LLM is fine-tuned using financial crime domain data. In one or more embodiments, the LLM is adapted to execute the real-time interaction with the one or more alert investigation agents by: understanding one or more inputs from the one or more alert investigation agents; creating a plan of action based on the one or more inputs, including determining which of the one or more databases to query; executing the plan of action, including parsing one or more results from the queried one or more databases; and responding to the one or more alert investigation agents. In one or more embodiments, to generate the one or more insights concerning the received financial crime alert, the one or more databases, or one or more additional databases, are further accessed using the queried GenAI-based application for additional information not including (i) or (ii).

A system for evaluating a financial crime alert received from a machine learning model (“MLM”) by one or more alert investigation agents has also been disclosed. The system generally includes: one or more databases; one or more computing devices adapted to: query a generative-artificial-intelligence-based (“GenAI-based”) application, via real-time interaction with the one or more alert investigation agents, for one or more insights concerning the received financial crime alert; and generate the one or more insights concerning the received financial crime alert by accessing, using the queried GenAI-based application, the one or more databases for: (i) information associated with the MLM's development and creation of the financial crime alert by the MLM; (ii) information regarding disposition of one or more historical financial crime alerts comparable to the received financial crime alert; or (iii) both (i) and (ii); and one or more output devices each accessible by the one or more alert investigation agents, and adapted to visualize, audibilize, or both, the generated one or more insights concerning the received financial crime alert. In one or more embodiments, the information regarding disposition of the one or more historical financial crime alerts comparable to the received financial crime alert is based on: (a) one or more text-comparisons between text from, or otherwise associated with, the received financial crime alert and other text from, or otherwise associated with, the one or more historical financial crime alerts; (b) one or more machine learning (“ML”) algorithms adapted to identify the one or more historical financial crime alerts comparable to the received financial crime alert; or (c) both (a) and (b). In one or more embodiments, the information regarding disposition of the one or more historical financial crime alerts comparable to the received financial crime alert is based on: (c) both (a) and (b). In one or more embodiments, the one or more databases are accessed using the queried GenAI-based application for: (iii) both (i) and (ii). In one or more embodiments, the one or more computing devices are further adapted to determine, based on the generated one or more insights, a confidence level for the received financial crime alert; and the one or more output devices are further adapted to visualize, audibilize, or both, the determined confidence level for the received financial crime alert. In one or more embodiments, the determined confidence level includes: a list of the one or more historical financial crime alerts comparable to the received financial crime alert; and a similarity score for each of the one or more historical financial crime alerts as compared to the received financial crime alert. In one or more embodiments, the information associated with the MLM's development and creation of the financial crime alert by the MLM includes: model development information for the MLM including data associated with the MLM's training; data analytics associated with the MLM's creation of the financial crime alert; or both of the foregoing. In one or more embodiments, the information regarding disposition of the one or more historical financial crime alerts comparable to the received financial crime alert is based on statistical analysis regarding disposition of multiple historical financial crime alerts. In one or more embodiments, the queried GenAI-based application is based on a large language model (“LLM”) adapted to execute the real-time interaction with the one or more alert investigation agents. In one or more embodiments, the LLM is fine-tuned using financial crime domain data. In one or more embodiments, the LLM is adapted to execute the real-time interaction with the one or more alert investigation agents by: understanding one or more inputs from the one or more alert investigation agents; creating a plan of action based on the one or more inputs, including determining which of the one or more databases to query; executing the plan of action, including parsing one or more results from the queried one or more databases; and responding to the one or more alert investigation agents. In one or more embodiments, to generate the one or more insights concerning the received financial crime alert, the one or more databases, or one or more additional databases, are further accessed using the queried GenAI-based application for additional information not including (i) or (ii).

A method for evaluating a financial crime alert received from a machine learning model (“MLM”) by one or more alert investigation agents has also been disclosed. The method generally includes: querying, using one or more computing devices, a generative-artificial-intelligence-based (“GenAI-based”) application, via real-time interaction with the one or more alert investigation agents, for one or more insights concerning the received financial crime alert; generating the one or more insights concerning the received financial crime alert by accessing, using the queried GenAI-based application, one or more databases for: (i) information associated with the MLM's development and creation of the financial crime alert by the MLM; (ii) information regarding disposition of one or more historical financial crime alerts comparable to the received financial crime alert; or (iii) both (i) and (ii); and visualizing, audibilizing, or both, via one or more output devices each accessible by the one or more alert investigation agents, the generated one or more insights concerning the received financial crime alert. In one or more embodiments, the information regarding disposition of the one or more historical financial crime alerts comparable to the received financial crime alert is based on: (a) one or more text-comparisons between text from, or otherwise associated with, the received financial crime alert and other text from, or otherwise associated with, the one or more historical financial crime alerts; (b) one or more machine learning (“ML”) algorithms adapted to identify the one or more historical financial crime alerts comparable to the received financial crime alert; or (c) both (a) and (b). In one or more embodiments, the information regarding disposition of the one or more historical financial crime alerts comparable to the received financial crime alert is based on: (c) both (a) and (b). In one or more embodiments, the one or more databases are accessed using the queried GenAI-based application for: (iii) both (i) and (ii). In one or more embodiments, the method further includes: determining, using the one or more computing devices and based on the generated one or more insights, a confidence level for the received financial crime alert; and visualizing, audibilizing, or both, via the one or more output devices, the determined confidence level for the received financial crime alert. In one or more embodiments, the determined confidence level includes: a list of the one or more historical financial crime alerts comparable to the received financial crime alert; and a similarity score for each of the one or more historical financial crime alerts as compared to the received financial crime alert. In one or more embodiments, the information associated with the MLM's development and creation of the financial crime alert by the MLM includes: model development information for the MLM including data associated with the MLM's training; data analytics associated with the MLM's creation of the financial crime alert; or both of the foregoing. In one or more embodiments, the information regarding disposition of the one or more historical financial crime alerts comparable to the received financial crime alert is based on statistical analysis regarding disposition of multiple historical financial crime alerts. In one or more embodiments, the queried GenAI-based application is based on a large language model (“LLM”) adapted to execute the real-time interaction with the one or more alert investigation agents. In one or more embodiments, the LLM is fine-tuned using financial crime domain data. In one or more embodiments, the LLM is adapted to execute the real-time interaction with the one or more alert investigation agents by: understanding one or more inputs from the one or more alert investigation agents; creating a plan of action based on the one or more inputs, including determining which of the one or more databases to query; executing the plan of action, including parsing one or more results from the queried one or more databases; and responding to the one or more alert investigation agents. In one or more embodiments, to generate the one or more insights concerning the received financial crime alert, the one or more databases, or one or more additional databases, are further accessed using the queried GenAI-based application for additional information not including (i) or (ii).

It is understood that variations may be made in the foregoing without departing from the scope of the present disclosure.

In one or more embodiments, the elements and teachings of the various embodiments may be combined in whole or in part in some (or all) of the embodiments. In addition, one or more of the elements and teachings of the various embodiments may be omitted, at least in part, and/or combined, at least in part, with one or more of the other elements and teachings of the various embodiments.

In one or more embodiments, while different steps, processes, and procedures are described as appearing as distinct acts, one or more of the steps, one or more of the processes, and/or one or more of the procedures may also be performed in different orders, simultaneously and/or sequentially. In one or more embodiments, the steps, processes, and/or procedures may be merged into one or more steps, processes and/or procedures.

In one or more embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although various embodiments have been described in detail above, the embodiments described are illustrative only and are not limiting, and those of ordinary skill in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A system for evaluating a financial crime alert received from a machine learning model (“MLM”) by one or more alert investigation agents, which system comprises:
one or more databases;
one or more computing devices adapted to:
query a generative-artificial-intelligence-based (“GenAI-based”) application, via real-time interaction with the one or more alert investigation agents, for one or more insights concerning the received financial crime alert; and
generate the one or more insights concerning the received financial crime alert by accessing, using the queried GenAI-based application, the one or more databases for:
(i) information associated with the MLM's development and creation of the financial crime alert by the MLM;
(ii) information regarding disposition of one or more historical financial crime alerts comparable to the received financial crime alert; or
(iii) both (i) and (ii);
and
one or more output devices each accessible by the one or more alert investigation agents, and adapted to visualize, audibilize, or both, the generated one or more insights concerning the received financial crime alert.

2. The system of claim 1, wherein the information regarding disposition of the one or more historical financial crime alerts comparable to the received financial crime alert is based on:
(a) one or more text-comparisons between text from, or otherwise associated with, the received financial crime alert and other text from, or otherwise associated with, the one or more historical financial crime alerts;
(b) one or more machine learning (“ML”) algorithms adapted to identify the one or more historical financial crime alerts comparable to the received financial crime alert; or
(c) both (a) and (b).

3. The system of claim 2, wherein the information regarding disposition of the one or more historical financial crime alerts comparable to the received financial crime alert is based on:
(c) both (a) and (b).

4. The system of claim 1, wherein the one or more databases are accessed using the queried GenAI-based application for:
(iii) both (i) and (ii).

5. The system of claim 1, wherein the one or more computing devices are further adapted to determine, based on the generated one or more insights, a confidence level for the received financial crime alert; and
wherein the one or more output devices are further adapted to visualize, audibilize, or both, the determined confidence level for the received financial crime alert.

6. The system of claim 5, wherein the determined confidence level includes:
a list of the one or more historical financial crime alerts comparable to the received financial crime alert; and
a similarity score for each of the one or more historical financial crime alerts as compared to the received financial crime alert.

7. The system of claim 1, wherein the information associated with the MLM's development and creation of the financial crime alert by the MLM includes:
model development information for the MLM including data associated with the MLM's training;
data analytics associated with the MLM's creation of the financial crime alert; or
both of the foregoing.

8. The system of claim 1, wherein the information regarding disposition of the one or more historical financial crime alerts comparable to the received financial crime alert is based on statistical analysis regarding disposition of multiple historical financial crime alerts.

9. The system of claim 1, wherein the queried GenAI-based application is based on a large language model (“LLM”) adapted to execute the real-time interaction with the one or more alert investigation agents.

10. The system of claim 9, wherein the LLM is fine-tuned using financial crime domain data.

11. The system of claim 9, wherein the LLM is adapted to execute the real-time interaction with the one or more alert investigation agents by:
understanding one or more inputs from the one or more alert investigation agents;
creating a plan of action based on the one or more inputs, including determining which of the one or more databases to query;
executing the plan of action, including parsing one or more results from the queried one or more databases; and
responding to the one or more alert investigation agents.

12. The system of claim 1, wherein, to generate the one or more insights concerning the received financial crime alert, the one or more databases, or one or more additional databases, are further accessed using the queried GenAI-based application for additional information not including (i) or (ii).

13. A method for evaluating a financial crime alert received from a machine learning model (“MLM”) by one or more alert investigation agents, which method comprises:
querying, using one or more computing devices, a generative-artificial-intelligence-based (“GenAI-based”) application, via real-time interaction with the one or more alert investigation agents, for one or more insights concerning the received financial crime alert;
generating the one or more insights concerning the received financial crime alert by accessing, using the queried GenAI-based application, one or more databases for:
(i) information associated with the MLM's development and creation of the financial crime alert by the MLM;
(ii) information regarding disposition of one or more historical financial crime alerts comparable to the received financial crime alert; or
(iii) both (i) and (ii);
and
visualizing, audibilizing, or both, via one or more output devices each accessible by the one or more alert investigation agents, the generated one or more insights concerning the received financial crime alert.

14. The method of claim 13, wherein the information regarding disposition of the one or more historical financial crime alerts comparable to the received financial crime alert is based on:
(a) one or more text-comparisons between text from, or otherwise associated with, the received financial crime alert and other text from, or otherwise associated with, the one or more historical financial crime alerts;
(b) one or more machine learning (“ML”) algorithms adapted to identify the one or more historical financial crime alerts comparable to the received financial crime alert; or
(c) both (a) and (b).

15. The method of claim 14, wherein the information regarding disposition of the one or more historical financial crime alerts comparable to the received financial crime alert is based on:
(c) both (a) and (b).

16. The method of claim 13, wherein the one or more databases are accessed using the queried GenAI-based application for:
(iii) both (i) and (ii).

17. The method of claim 13, further comprising:
determining, using the one or more computing devices and based on the generated one or more insights, a confidence level for the received financial crime alert; and
visualizing, audibilizing, or both, via the one or more output devices, the determined confidence level for the received financial crime alert.

18. The method of claim 17, wherein the determined confidence level includes:
a list of the one or more historical financial crime alerts comparable to the received financial crime alert; and
a similarity score for each of the one or more historical financial crime alerts as compared to the received financial crime alert.

19. The method of claim 13, wherein the information associated with the MLM's development and creation of the financial crime alert by the MLM includes:
model development information for the MLM including data associated with the MLM's training;
data analytics associated with the MLM's creation of the financial crime alert; or
both of the foregoing.

20. The method of claim 13, wherein the information regarding disposition of the one or more historical financial crime alerts comparable to the received financial crime alert is based on statistical analysis regarding disposition of multiple historical financial crime alerts.

21. The method of claim 13, wherein the queried GenAI-based application is based on a large language model (“LLM”) adapted to execute the real-time interaction with the one or more alert investigation agents.

22. The method of claim 21, wherein the LLM is fine-tuned using financial crime domain data.

23. The method of claim 21, wherein the LLM is adapted to execute the real-time interaction with the one or more alert investigation agents by:
understanding one or more inputs from the one or more alert investigation agents;
creating a plan of action based on the one or more inputs, including determining which of the one or more databases to query;
executing the plan of action, including parsing one or more results from the queried one or more databases; and
responding to the one or more alert investigation agents.

24. The method of claim 1, wherein, to generate the one or more insights concerning the received financial crime alert, the one or more databases, or one or more additional databases, are further accessed using the queried GenAI-based application for additional information not including (i) or (ii).
